(19) United States
(12) Patent Application Publication
(10) Pub. No.: US 2023/0356231 A1
(43) Pub. Date: Nov. 9, 2023

(54) TEMPERATURE CONTROL METHODS AND DEVICES

(71) Applicant: 10x Genomics, Inc., Pleasanton, CA (US)

(72) Inventors: Michael John TIERNEY, Pleasanton, CA (US); Bill Kengli LIN, Pleasanton, CA (US); Rajiv VERMA, Pleasanton, CA (US); Lynna CHEN, Oakland, CA (US); Kevin GILMARTIN, Belmont, CA (US); Rajiv BHARADWAJ, Pleasanton, CA (US)

(21) Appl. No.: 18/223,903

(22) Filed: Jul. 19, 2023

Related U.S. Application Data
(63) Continuation of application No. PCT/US2022/012918, filed on Jan. 19, 2022.
(60) Provisional application No. 63/139,000, filed on Jan. 19, 2021.

(51) Int. Cl. B01L 7/00; B01L 3/00

(52) U.S. Cl. CPC B01L 7/52; B01L 3/502707

(57) ABSTRACT

The invention provides methods for rapid setting, adjusting, and controlling the temperature of a microfluidic device.

### BACKGROUND OF THE INVENTION

Microfluidic devices and methods have revolutionized high-throughput and high-fidelity bioassays. Precise control of temperature within a microfluidic device has been a challenge in the field. Accordingly, there is a need for improved devices and methods that provide precise temperature control of microfluidic devices.

### SUMMARY OF THE INVENTION

The invention provides methods for rapidly setting, adjusting, and controlling the temperature of a microfluidic device (e.g., to improve assay quality and reproducibility).

In one aspect, the invention provides a method for controlling temperature of a microfluidic device by providing an instrument for performing an assay at a first temperature, the instrument having a housing and a tray for inserting the microfluidic device into the housing and removing the microfluidic device from the housing, the tray having a thermal energy source, and the instrument having a first temperature sensor to determine ambient temperature and a second temperature sensor to determine a temperature of the tray and/or microfluidic device and placing the microfluidic device in the tray and inserting the microfluidic device into the housing. The instrument determines a difference between the ambient temperature and the first temperature and energizes the thermal energy source to heat or cool the microfluidic device by overshooting the first temperature and then reducing the overshoot until the microfluidic device reaches the first temperature or by preheating or precooling the tray relative to ambient temperature until the microfluidic device reaches the first temperature, e.g., as determined from the second temperature sensor.

In some embodiments, the thermal energy source includes a thermoelectric cooler (TEC), e.g., having a heatsink.

In some embodiments, the first and second temperature sensors include independently located thermistors. In some embodiments, the instrument includes a third temperature sensor (e.g., an infrared sensor) for the microfluidic device, e.g., when the second temperature sensor is in the tray.

In some embodiments the thermal energy source heats or cools the microfluidic device by overshooting the first temperature and then reducing the overshoot until the microfluidic device reaches the first temperature. In some embodiments, the overshoot initiates with insertion of the tray into the instrument. In some embodiments, the thermal energy source preheats or precools the tray prior to insertion into the housing. In some embodiments, the microfluidic device is placed in a thermally conductive holder, which is placed in the tray.

In some embodiments, the ambient temperature is between 15° C. and 30° C. In some embodiments, the first temperature is between 20° C. and 25° C. In some embodiments, the temperature of the microfluidic device reaches a temperature within 1° C. of the first temperature in less than 60 seconds, e.g., less than 30 seconds or less than 15 seconds. In some embodiments, the temperature of the microfluidic device reaches a temperature within 0.5° C. of the first temperature in less than 60 seconds, e.g., less than 30 seconds or less than 15 seconds.

In another aspect, the invention provides a device having a housing and a tray for inserting a microfluidic device into the housing and removing the microfluidic device from the housing and a thermal energy source, a first temperature sensor to determine ambient temperature and a second temperature sensor to determine a temperature of the tray and/or microfluidic device. The device is programmed to determine a difference between the ambient temperature and a first temperature and energizes the thermal energy source to heat or cool the microfluidic device by overshooting the first temperature and then reducing the overshoot until the microfluidic device reaches the first temperature, e.g., as determined from the second temperature sensor, or by preheating or precooling the tray relative to ambient until the microfluidic device reaches the first temperature, e.g., as determined from the second temperature sensor.

In some embodiments, the thermal energy source includes a thermoelectric cooler (TEC), e.g., having a heatsink. In some embodiments, the first and second temperature sensors include independently located thermistors. In some embodiments, the device includes a third temperature sensor (e.g., an infrared sensor) for the microfluidic device, e.g., when the second temperature sensor is in the tray. In some embodiments, the third temperature sensor includes an infrared sensor. In some embodiments, the thermal energy source heats or cools the microfluidic device by overshooting the first temperature and then reducing the overshoot until the microfluidic device reaches the first temperature. In some embodiments, the overshoot initiates with insertion of the tray into the instrument. In some embodiments, the thermal energy source preheats or precools the tray prior to insertion into the housing.

In some embodiments, the microfluidic device is placed in a thermally conductive holder, which is placed in the tray. In some embodiments, ambient temperature is between 15° C. and 30° C. In some embodiments, the first temperature is between 20° C. and 25° C. In some embodiments, the temperature of the microfluidic device reaches a temperature within 1° C. of the first temperature in less than 60 seconds, e.g., less than 30 seconds or less than 15 seconds. In some embodiments, the temperature of the microfluidic device reaches a temperature within 0.5° C. of the first temperature in less than 60 seconds, e.g., less than 30 seconds or less than 15 seconds.

In one aspect, the invention provides a method for controlling temperature of a microfluidic device by providing an instrument for performing an assay at a first temperature, the instrument having a housing and a tray for inserting the microfluidic device into the housing and removing the microfluidic device from the housing, the tray having a thermal energy source, and the instrument having a first temperature sensor to determine ambient temperature and a coupling for a second temperature sensor in the microfluidic device and placing the microfluidic device in the tray and inserting the microfluidic device into the housing. The instrument determines a difference between the ambient temperature and the first temperature and energizes the thermal energy source to heat or cool the microfluidic device by overshooting the first temperature and then reducing the overshoot until the microfluidic device reaches the first temperature, e.g., as determined from the second temperature sensor, or by preheating or precooling the tray relative to ambient temperature until the microfluidic device reaches the first temperature, e.g., as determined from the second temperature sensor.

In some embodiments, the thermal energy source includes a thermoelectric cooler (TEC), e.g., having a heatsink.

In some embodiments, the first and second temperature sensors include thermistors.

In some embodiments the thermal energy source heats or cools the microfluidic device by overshooting the first temperature and then reducing the overshoot until the microfluidic device reaches the first temperature. In some embodiments, the overshoot initiates with insertion of the tray into the instrument. In some embodiments, the thermal energy source preheats or precools the tray prior to insertion into the housing. In some embodiments, the microfluidic device is placed in a thermally conductive holder, which is placed in the tray.

In some embodiments, the ambient temperature is between 15° C. and 30° C. In some embodiments, the first temperature is between 20° C. and 25° C. In some embodiments, the temperature of the microfluidic device reaches a temperature within 1° C. of the first temperature in less than 60 seconds, e.g., less than 30 seconds or less than 15 seconds. In some embodiments, the temperature of the microfluidic device reaches a temperature within 0.5° C. of the first temperature in less than 60 seconds, e.g., less than 30 seconds or less than 15 seconds.

In another aspect, the invention provides a device having a housing and a tray for inserting a microfluidic device into the housing and removing the microfluidic device from the housing and a thermal energy source, a first temperature sensor to determine ambient temperature and a coupling for a second temperature sensor in the microfluidic device. The device is programmed to determine a difference between the ambient temperature and a first temperature and energizes the thermal energy source to heat or cool the microfluidic device by overshooting the first temperature and then reducing the overshoot until the microfluidic device reaches the first temperature, e.g., as determined from the second temperature sensor, or by preheating or precooling the tray relative to ambient until the microfluidic device reaches the first temperature, e.g., as determined from the second temperature sensor.

In some embodiments, the thermal energy source includes a thermoelectric cooler (TEC), e.g., having a heatsink. In some embodiments, the first and second temperature sensors include thermistors. In some embodiments, the third temperature sensor includes an infrared sensor. In some embodiments, the thermal energy source heats or cools the microfluidic device by overshooting the first temperature and then reducing the overshoot until the microfluidic device reaches the first temperature. In some embodiments, the overshoot initiates with insertion of the tray into the instrument. In some embodiments, the thermal energy source preheats or precools the tray prior to insertion into the housing.

In some embodiments, the microfluidic device is placed in a thermally conductive holder, which is placed in the tray. In some embodiments, ambient temperature is between 15° C. and 30° C. In some embodiments, the first temperature is between 20° C. and 25° C. In some embodiments, the temperature of the microfluidic device reaches a temperature within 1° C. of the first temperature in less than 60 seconds, e.g., less than 30 seconds or less than 15 seconds. In some embodiments, the temperature of the microfluidic device reaches a temperature within 0.5° C. of the first temperature in less than 60 seconds, e.g., less than 30 seconds or less than 15 seconds.

### Definitions

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, the term “about” refers to a value that is within 10% above or below the value being described.

As used herein, the term “overshooting” refers to setting the set point of a thermal energy device to reach an equilibrium temperature than is higher (when heating) or lower (when cooling) than the desired assay temperature.

As used herein, the term “reaches a temperature” refers to the state of at least a portion of an object measured as being at that temperature±at most 1° C., e.g., at most 0.5° C. or at most 0.1° C., including normal fluctuations. The term does not require that the entirety of an object be at the same temperature. The temperature of the object may also be measured directly, e.g., with an embedded sensor, a sensor in contact with the device, or a remote sensor, e.g., an IR sensor. The temperature of the object may also be inferred from the temperature of another component in thermal contact with the device, e.g., a secondary holder for a microfluidic device.

### BRIEF DESCRIPTION OF THE DRAWINGS

FIG. 1 is a graph showing the temperature profile of a tray, a microfluidic device, a heatsink, and ambient temperature over time in an experiment where the set temperature (28° C.) was higher than the ambient temperature (20° C.). All components begin at ambient temperature as shown at second 200.

FIG. 2 is a graph showing the temperature profile of a tray, a microfluidic device, a heatsink, and ambient temperature over time in an experiment where the set temperature (13° C.) was lower than the ambient temperature (20° C.). All components begin at ambient temperature as shown at second 200.

FIG. 3 is a graph showing the temperature profile of a thermal energy source, preheated at 27° C., a microfluidic device, a heatsink, the instrument housing, and ambient temperature over time.

FIG. 4 is a graph showing the temperature profile of a thermal energy source, precooled at about 14° C., a microfluidic device, and ambient temperature over time.

FIG. 5A-5B are block diagrams illustrating exemplary embodiments of instruments. FIG. 5A shows an embodiment in which the instrument includes a first temperature sensor disposed to detect ambient temperature, a second temperature sensor disposed to detect the temperature of the tray, and a third temperature sensor disposed to detect the temperature of the microfluidic device. The thick arrow to the third temperature sensor represents IR radiation from the microfluidic device. FIG. 5B shows an embodiment in which the instrument includes a first temperature sensor disposed to detect ambient temperature and a coupling to second temperature sensor in the microfluidic device. The dashed line illustrates a wireless communication between the coupling and the second temperature sensor.

### DETAILED DESCRIPTION OF THE INVENTION

In general, the invention features methods and devices for control of temperature of a microfluidic device. The invention allows for reaching an assay temperature more rapidly, thereby shortening total assay time. Temperature adjustment from ambient temperature to a first temperature may be automated by appropriate software and/or hardware.

Instrument and Components

Assay Instrument

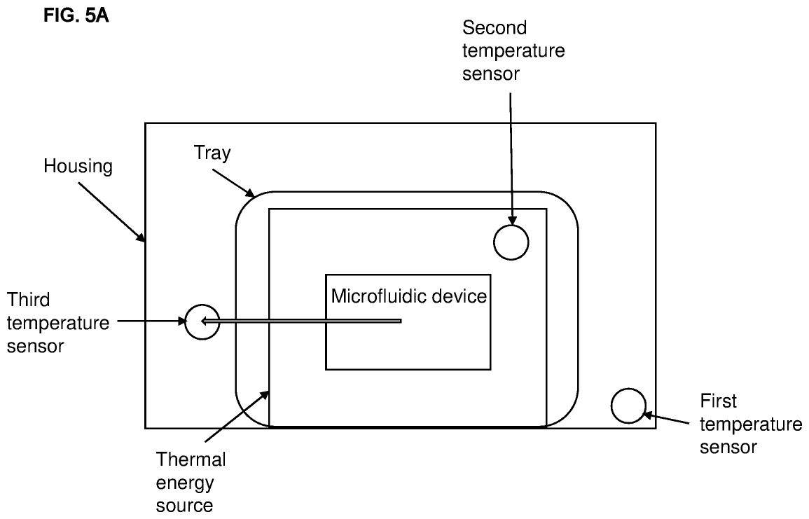

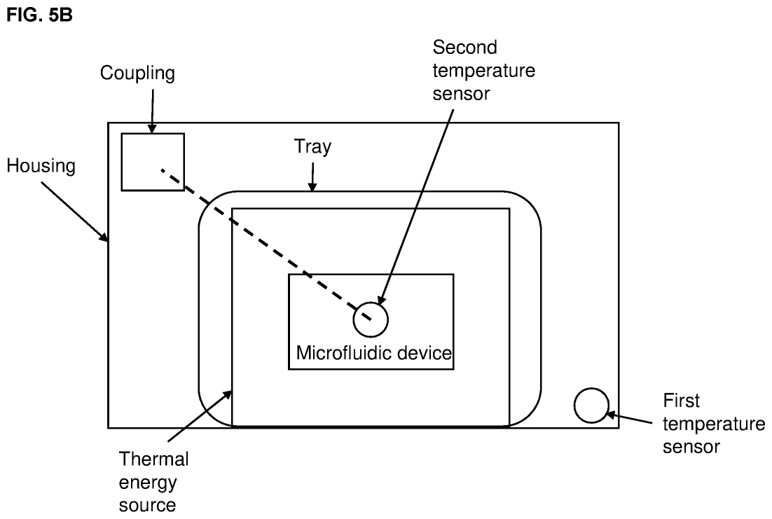

The assay instrument of the invention can be any instrument for performing biological, biochemical, chemical, physical, or biophysical assays (e.g., sequencing of genetic information, e.g., DNA sequencing, RNA sequencing, protein sequencing, peptide sequencing, amplifying genetic information (e.g., DNA amplification, RNA amplification, e.g., polymerase chain reaction), biomarker detection, droplet generation, and single-cell assays (e.g., RNA-seq, encapsulation of single cells in droplets). The instrument includes a housing and a tray and brings at least one microfluidic device (e.g., 1, 2, 3, 4, 5, 6, 7, 8, 9, or 10 microfluidic devices) to a desired first temperature prior to performing an assay (FIGS. 5A and 5B). The instrument may also include other sensors, e.g., to determine when the tray is opened or closed (or the position may be determined by software), or to determine if a microfluidic device is present in the tray.

### Housing and Tray

The housing generally provides an environment for at least one microfluidic device to be maintained at a desired first temperature. The housing need not be airtight. The housing also may enclose various components for carrying out one or more assays including controllers, reagent reservoirs, pumps, gas or liquid manifolds, detectors, etc. The housing may be of any suitable shape and constructed of any suitable material, e.g., a metal, a plastic, a glass, or a ceramic material. The instrument also includes at least one tray (e.g., 1, 2, 3, 4, 5, 6, 7, 8, 9, or 10 trays). The tray transports a microfluidic device into and out of the housing. Transport may occur manually, e.g., by a spring and catch mechanism), or in an automated fashion, e.g., controlled by a controller in the housing. In some embodiments, the microfluidic device may be placed in a secondary holder which is placed in the tray. In some embodiments, the tray is made of a thermally conductive material (e.g., a metal or metalized material). Multiple trays may work in coordination or independently and transport at least one microfluidic device each into and out from the instrument. The housing will also typically enclose other components necessary to carry out an assay, e.g., pneumatic manifold or other pumps, computer or other controller for directing the operation of the instrument, fans, and any other necessary component for a particular assay.

### Thermal Energy Source

The instrument of the invention includes a thermal energy source that can heat or cool the microfluidic device. In some embodiments, the thermal energy source is a thermoelectric cooler (TEC). Other thermal energy sources are known in the art, e.g., resistive heaters, circulating fluid baths, etc. The thermal energy source can also include a heatsink on at least one of its sides. In some embodiments, the thermal energy source heats or cools the microfluidic device, e.g., disposed in a holder, to an assay temperature (within ±1° C., e.g., within ±0.5° C. or within ±0.1° C.) in less than 90 seconds, e.g., less than 60, less than 30 seconds or less than 15 seconds, such as between 5 and 90 seconds, e.g., between 10 and 60 seconds, or about 60, about 30, or about 15 seconds. In some embodiments, the thermal energy source has a temperature resolution of 0.1° C.

The thermal energy source may be configured to respond to a command from a controller to either heat or cool the tray. In some embodiments the thermal energy source can transition from heating mode to cooling mode repeatedly and in response to a series of commands from the controller. In some embodiments, the thermal energy source can cool or heat at varying rates whereby the trajectory of heating or cooling can change over time. In some embodiments, the thermal energy source responds to a computer program to control the rate of heating or cooling over time, also called the temperature profile.

The instrument of the invention may include more than one thermal energy source (e.g., 2, 3, 4, 5, 6, 7, 8, 9, or 10 thermal energy sources). Multiple thermal energy sources may be employed with a single microfluidic device, or a single thermal energy source may be used for two or more microfluidic devices. Thermal energy sources may be positioned to heat or cool the microfluidic device directly, e.g., in contact with the microfluidic device, or indirectly, e.g., via a conductive medium, such as air or metal, e.g., in a holder. Conductive greases, liquids, or pastes may also be employed. Thermal energy sources may be present in the tray, the housing, or both.

### Temperature Sensors

The instrument of the invention includes a plurality of temperature sensors, (e.g., thermistors or infrared sensors). In some embodiments the temperatures sensors can measure and report the temperature measurements at a frequency between about 1 Hz and 100 Hz (e.g., between about 1 and about 10 Hz, between about 10 and about 100 Hz, e.g., about 10 Hz, about 11 Hz, about 12 Hz, about 13 Hz, about 14 Hz, about 15 Hz, about 16 Hz, about 17 Hz, about 18 Hz, about 19 Hz, about 20 Hz, about 21 Hz, about 22 Hz, about 23 Hz, about 24 Hz, about 25 Hz, about 26 Hz, about 27 Hz, about 28 Hz, about 29 Hz, about 30 Hz, about 31 Hz, about 32 Hz, about 33 Hz, about 34 Hz, about 35 Hz, about 36 Hz, about 37 Hz, about 38 Hz, about 39 Hz, about 40 Hz, about 41 Hz, about 42 Hz, about 43 Hz, about 44 Hz, about 45 Hz, about 46 Hz, about 47 Hz, about 48 Hz, about 49 Hz, about 50 Hz, about 51 Hz, about 52 Hz, about 53 Hz, about 54 Hz, about 55 Hz, about 56 Hz, about 57 Hz, about 58 Hz, about 59 Hz, about 60 Hz, about 61 Hz, about 62 Hz, about 63 Hz, about 64 Hz, about 65 Hz, about 66 Hz, about 67 Hz, about 68 Hz, about 69 Hz, about 70 Hz, about 71 Hz, about 72 Hz, about 73 Hz, about 74 Hz, about 75 Hz, about 76 Hz, about 77 Hz, about 78 Hz, about 79 Hz, about 80 Hz, about 81 Hz, about 82 Hz, about 83 Hz, about 84 Hz, about 85 Hz, about 86 Hz, about 87 Hz, about 88 Hz, about 89 Hz, about 90 Hz, about 91 Hz, about 92 Hz, about 93 Hz, about 94 Hz, about 95 Hz, about 96 Hz, about 97 Hz, about 98 Hz, about 99 Hz, or about 100 Hz). In some embodiments, the instrument includes at least one temperature sensor that measures an ambient temperature. In some embodiments, the instrument includes at least one temperature sensor that measures the temperature of the microfluidic device or the tray. The instrument may include temperature sensors for both the tray and the microfluidic device (e.g., FIG. 5A). Temperature sensors may also monitor the temperature of the housing and/or a heatsink. The temperature sensors can be configured to provide temperature information in real-time to a controller of the instrument to inform an adjustment in heating or cooling by the thermal energy source. In some embodiments the temperature sensors can detect a change in temperature of 0.1° C. The temperature sensors can be placed in any suitable location. For example, a sensor for ambient temperature may be attached to the housing or the tray. Sensors for the tray or microfluidic device may be located in the tray or the housing. Sensors may or may not be physically in contact with the tray or microfluidic device.

The instrument may also operatively couple, e.g., by wired or wireless connection, with temperature sensors in or on the microfluidic device, e.g., adjacent the channels or on the outside of the device (e.g., FIG. 5B). For example, the microfluidic device may include Bluetooth, nearfield wifi, or other wireless components to provide temperature information to the instrument. Alternatively, the microfluidic device may include a physical connector that mates with the instrument, e.g., via the tray, to provide temperature information to the instrument.

### Microfluidic Devices

The instrument and methods of the invention are configured to control the temperature of at least one microfluidic device. The microfluidic device may be configured and used for various applications, such as, for example, to generate droplets, to evaluate and/or quantify the presence of a biological particle or organism (e.g., microbiome analysis, environmental testing, food safety testing, epidemiological analysis), to process a single analyte (e.g., bioanalytes, e.g., RNA, DNA, or protein) or multiple analytes (e.g., bioanalytes, e.g., DNA and RNA, DNA and protein, RNA and protein, or RNA, DNA and protein) from a single cell or from multiple cells, to process, for example, proteomic, transcriptomic, and/or genomic analysis of a cell or population of cells (e.g., simultaneous proteomic, transcriptomic, and/or genomic analysis of a cell or population of cells), or to modify analytes. Exemplary microfluidic devices for producing droplets are described in WO 2019/040637, WO 2020/123657, WO 2020/176882, and WO 2015/157567, the microfluidic devices of which are incorporated by reference. Holders for such devices are known in the art, e.g., as described in U.S. Pat. No. 9,975,122, the holders of which are incorporated by reference herein.

### Methods of Use

The invention provides control of the temperature of a microfluidic device. In general, the instrument determines an ambient temperature, e.g., via a first temperature sensor, and a tray (FIG. 5A) or microfluidic device temperature (FIGS. 5A-5B), e.g., via a second temperature sensor and optionally a third temperature sensor, when sensors are employed for the tray and device. When the second sensor is in the tray, the temperature of the tray is used as a proxy for the temperature of the microfluidic device, e.g., with a known (e.g., measured empirically) or calculated offset. Ambient temperature is typically between 15-30° C. The assay temperature may be any suitable value above or below ambient, e.g., ±about 5° C. to 90° C., e.g., about ±about 5° C. to 30° C. In some embodiments, the methods provide the ability to control the temperature of a plurality of microfluidic devices, which can be brought to a first temperature independently, in a sequential manner, in a coordinated manner, or simultaneously. For a plurality of microfluidic devices, the first temperature may be the same or different for each device. In some embodiments, the microfluidic device includes a set of instructions that is read by the instrument. The instructions determine the temperature for the assay to be performed with the microfluidic device and may also include information about the fluidic parameters to be used (e.g., pressure).

### Overshooting

In some embodiments, the change in temperature employs overshooting. In these methods, the instrument sets the set point of the thermal energy source to an equilibrium point higher or lower than the assay temperature, e.g., at least about 5° C., such as about 5-20° C., e.g., about 8-15° C., e.g., about 8° C. or about 10° C. As the microfluidic device approaches the assay temperature, the instrument changes the set point of the thermal energy source to allow the microfluidic device to reach the first temperature. The microfluidic device may pass the assay temperature during the overshoot prior to reaching the equilibrium assay temperature. The overshooting may begin before the tray is opened, as the tray is opened, once a microfluidic device is inserted, or once the tray is being closed or closed. After the overshooting, the temperature of the tray may be held at the assay temperature or at a temperature (e.g., ±about 1-6° C.) above or below to offset heat loss or gain. The overshoot may last for a specified period of time, e.g., between 5 and 90 seconds, e.g., between 15 and 60 seconds, between 20 and 45 second, or about 15, about 30, about 45, or about 60 seconds.

In some embodiments, overshooting can bring at least one microfluidic device to a first temperature in less than about 90 seconds (e.g., less than 60 seconds, less than 30 seconds, or less than 15 seconds, or between 10 and 90 seconds, 15 and 60 seconds, 10 and 45 seconds, or 45 and 90 seconds, e.g., about 15 seconds, about 30 seconds, about 45 seconds, or about 60 seconds).

### Preheating or Precooling

In some embodiments, the methods of the invention employ preheating or precooling of the tray or microfluidic device. Preheating or precooling may be performed prior to insertion of the microfluidic device into the housing. In some embodiments, the instrument preheats or precools and maintains the tray at a baseline temperature. In some embodiments, the instrument heats or cools the tray while the tray is open to bring the microfluidic device to temperature quicker. The preheating or precooling may begin before the tray is opened, as the tray is opened, once a microfluidic device is inserted, or once the tray is being closed. The temperature of the tray may be held at the assay temperature or at a temperature (e.g., ±about 1-6° C.) above or below to offset heat loss or gain.

In some embodiments, preheating or precooling can bring at least one microfluidic device to a first temperature in less than about 90 seconds (e.g., less than 60 seconds, less than 30 seconds, or less than 15 seconds, or between 10 and 90 seconds, 15 and 60 seconds, 10 and 45 seconds, or 45 and 90 seconds, e.g., about 15 seconds, about 30 seconds, about 45 seconds, or about 60 seconds).

In some embodiments, the instrument is capable of running various assays at different temperatures, e.g., where the assay temperature is determined by reading instructions or indicia on the microfluidic device. In these embodiments, the tray may be heated or cooled to a starting temperature from which the instrument will heat or cool to reach the final assay temperature that depends on the assay being performed. In such embodiments, overshooting may be employed once the assay is determined.

Combinations of preheating/precooling and overshooting are also contemplated, where the preheating or precooling is to a starting temperature and the overshooting allows the device to reach the assay temperature faster.

### Temperature Control

In some embodiments, the temperature of a tray or microfluidic device is controlled based on a computer program that determines a heating or cooling profile based on inputs from one or more temperature sensors, e.g., a sensor for ambient or a sensor for the tray. The profile may be a linear ramp up (e.g., heating) or ramp down (e.g., cooling) until the device temperature reaches the assay temperature. Other profiles, e.g., exponential or stepped, may be employed. The profile may be calculated based on inputs, or the profile may be stored in a look up table, where the ramp and power requirements are determined based on the difference between the ambient temperature or starting tray temperature and the assay temperature. Once the assay temperature is reached, the thermal energy source may be held at a temperature (e.g., ±about 1-6° C.) to offset heat loss or heat gain to maintain the microfluidic device at the assay temperature.

### EXAMPLES

The following examples are put forth so as to provide those of ordinary skill in the art with a description of how the compositions and methods described herein may be used, made, and evaluated, and are intended to be purely exemplary of the invention and are not intended to limit the scope of what the inventors regard as their invention.

### Example 1. Fast Heating of Microfluidic Devices from Ambient Temperature

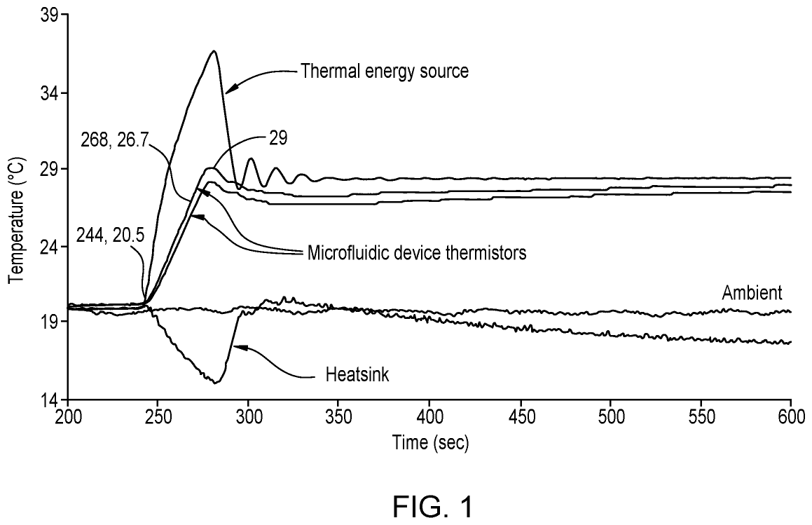

In this example, the microfluidic device, the thermal energy source, and ambient temperature were below the desired setpoint temperature (27° C.). FIG. 1 shows time in seconds on the horizontal axis and temperature in ° C. on the vertical axis. Ambient temperature was about 20° C. The sequence was as follows:
(1) Start at 20° C. and hold for 240 seconds;
(2) Then go to 37° C. (overshoot temperature to get the microfluidic device to 27° C. rapidly) for 45 seconds;
(3) Then go to 29° C. (offset temperature to keep microfluidic device at 27° C.) and hold.
   The two thermistors were located mid-line and equidistant from the center adjacent the microfluidic channels. The steep slope of their initial response to the tray temperature shows the effect of the overshoot temperature.

### Example 2. Fast Cooling of Microfluidic Devices from Ambient Temperature

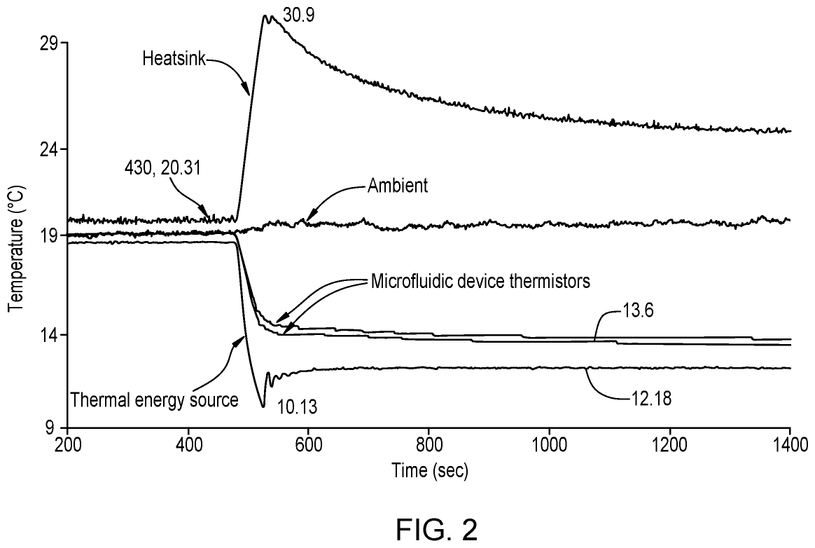

In this example, the microfluidic device, the thermal energy source, and ambient temperature were above the desired setpoint temperature (14° C.). FIG. 2 shows time in seconds on the horizontal axis and temperature in ° C. on the vertical axis. Ambient temperature was between 19° C. and 20° C. The sequence was as follows:
(1) Start at 19° C. and hold for 480 seconds;
(2) Then go to 6° C. (overshoot temperature to get the microfluidic device to 14° C. rapidly) for 45 seconds
(3) Then go to 12° C. (offset temperature to keep microfluidic device at 14° C.) and hold.
   The two thermistors were located mid-line and equidistant from the center adjacent the microfluidic channels. The steep downward slope of their initial response to the tray temperature shows the effect of the overshoot temperature.

### Example 3. Fast Heating of Microfluidic Devices from Offset Temperature

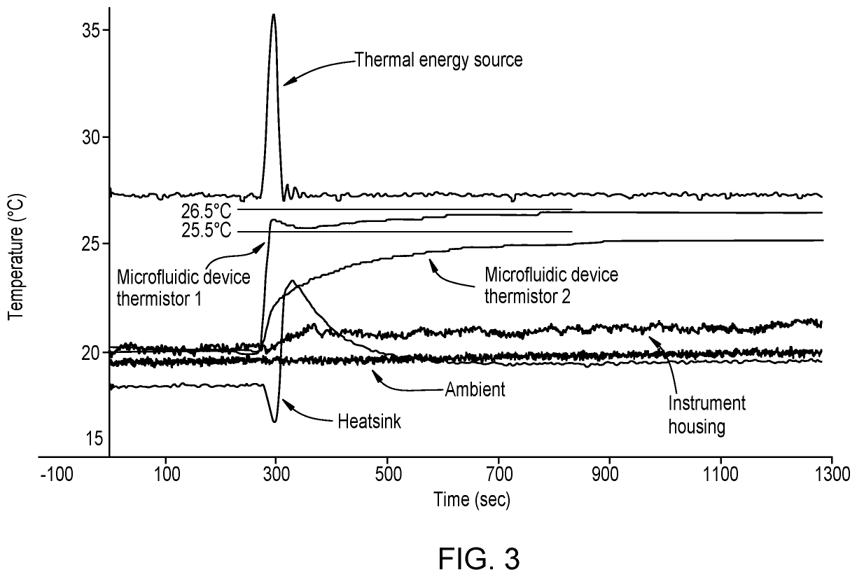

In this example, the microfluidic device and ambient temperature were below the desired setpoint temperature (26° C.). The thermal energy source was preheated and maintained at an offset temperature (27° C.). FIG. 3 shows time in seconds on the horizontal axis and temperature in ° C. on the vertical axis. Ambient temperature was between 19° C. and 20° C. The sequence was as follows:
(1) the thermal energy source started at 27° C., the microfluidic device started at ambient temperature (about 20° C.) and the temperatures were held for 270 seconds;
(2) then the microfluidic device was inserted into the tray, and the tray retracted into the instrument to initiate the heating. The thermal energy source went to 36° C. for 25 seconds;
(3) then the thermal energy source went back to 27° C. (offset temperature to keep the microfluidic device at 26° C.) and was held at the offset temperature.
   Two thermistors placed in the microfluidic device. Thermistor 1 was adjacent the microfluidic channels, and thermistor 2 was on the side of the microfluidic device. The temperature of the instrument housing was also monitored by a thermistor placed inside the instrument housing The temperature of the heatsink was also monitored by a thermistor placed on the heatsink.

### Example 4. Fast Cooling of Microfluidic Devices from Offset Temperature

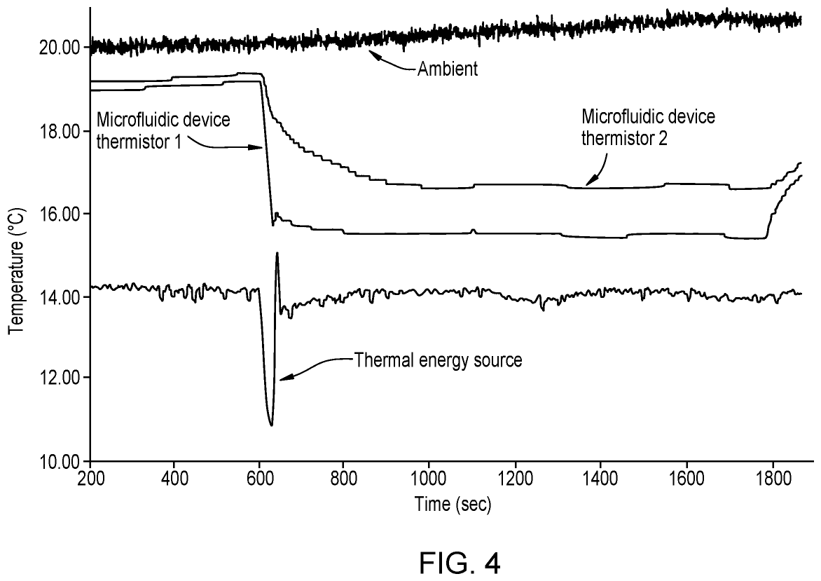

In this example, the microfluidic device and ambient temperature are above the desired setpoint temperature (16° C.). The thermal energy source is precooled and maintained at an offset temperature (14° C.). FIG. 4 shows time in seconds on the horizontal axis and temperature in ° C. on the vertical axis. Ambient temperature was about 20° C. The sequence was as follows:
(1) the thermal energy source started at 14° C., the microfluidic device started near ambient temperature (about 19° C.) and the temperatures were held for 400 seconds;
(2) then the microfluidic device was inserted into the tray and the tray retracted into the instrument to initiate the cooling. The thermal energy source went to about 11° C. (overshoot temperature to get the microfluidic device to 16° C. rapidly) for 30 seconds;
(3) then the thermal energy source went back to 14° C. (offset temperature to keep the microfluidic device at 16° C.) and was held at the offset temperature.

Thermistor 1 was adjacent the microfluidic channels, and thermistor 2 was on the side of the microfluidic device. Thermistor 2 illustrated the temperature gradient across the microfluidic device, which can be used to determine an offset for the temperature of the tray versus the microfluidic device. The output of a thermistor placed on the thermal energy source was also monitored. The steep downward slope of their initial response to the tray temperature shows the effect of the overshoot temperature.

### Embodiments of the Invention

1. A method for controlling temperature of a microfluidic device comprising:
   i) providing an instrument for performing an assay at a first temperature, wherein the instrument comprises a housing and a tray for inserting the microfluidic device into the housing and removing the microfluidic device from the housing, wherein the tray comprises a thermal energy source, and the instrument comprises a first temperature sensor to determine an ambient temperature and a second temperature sensor to determine the temperature of the tray and/or microfluidic device; and
   ii) placing the microfluidic device in the tray and inserting the microfluidic device into the housing, wherein the instrument determines a difference between the ambient temperature and the first temperature and energizes the thermal energy source to heat or cool the microfluidic device by overshooting the first temperature and then reducing the overshoot until the microfluidic device reaches the first temperature or by preheating or precooling the tray relative to ambient temperature until the microfluidic device reaches the first temperature.
2. The method of any one of embodiments 1 and 3-13, wherein the thermal energy source comprises a thermoelectric cooler (TEC) comprising a heatsink.
3. The method of any one of embodiments 1-2 and 4-13, wherein the first and second temperature sensors comprise thermistors.
4. The method of any one of embodiments 1-3 and 5-13, further comprising a third temperature sensor for the microfluidic device.
5. The method of embodiment 4, wherein the third temperature sensor is an infrared sensor.
6. The method of any one of embodiments 1-5 and 7-13, wherein the thermal energy source heats or cools the microfluidic device by overshooting the first temperature and then reducing the overshoot until the microfluidic device reaches the first temperature.
7. The method of embodiment 6, wherein the overshoot initiates with insertion of the tray into the instrument.
8. The method of any one of embodiments 1-7 and 9-13, wherein the thermal energy source preheats or precools the tray prior to insertion into the housing.
9. The method of any one of embodiments 1-8 and 10-13, wherein the microfluidic device is placed in a thermally conductive holder, which is placed in the tray.
10. The method of any one of embodiments 1-9 and 11-13, wherein the ambient temperature is between 15° C. and 30° C.
11. The method of any one of embodiments 1-10 and 12-13, wherein the first temperature is between 20° C. and 25° C.
12. The method of any one of embodiments 1-11 and 13, wherein the temperature of the microfluidic device reaches a temperature within 1° C. the first temperature in less than 60 seconds.
13. The method of any one of embodiments 1-12 and 14, wherein the temperature of the microfluidic device reaches a temperature within 0.5° C. of the first temperature in less than 60 seconds.
14. The method of any one of embodiments 1-13, wherein the temperature of the microfluidic device is determined from the second temperature sensor.
15. A device comprising:
   i) a housing and a tray for inserting a microfluidic device into the housing and removing the microfluidic device from the housing; and
   ii) a thermal energy source, a first temperature sensor to determine an ambient temperature and a second temperature sensor to determine temperature of the tray and/or microfluidic device;
wherein the device is programmed to determine a difference between the ambient temperature and a first temperature and energizes the thermal energy source to heat or cool the microfluidic device by overshooting the first temperature and then reducing the overshoot until the microfluidic device reaches the first temperature or by preheating or precooling the tray relative to ambient until the microfluidic device reaches the first temperature.
16. The device of any one of embodiments 15 and 17-28, wherein the thermal energy source comprises a thermoelectric cooler (TEC) comprising a heatsink.
17. The device of any one of embodiments 15-16 and 18-28, wherein the first and second temperature sensors comprise thermistors.
18. The device of any one of embodiments 15-17 and 19-2287, further comprising a third temperature sensor for the microfluidic device.
19. The device of embodiment 18, wherein the third temperature sensor is an infrared sensor.
20. The device of any one of embodiments 15-19 and 2120-28, wherein the thermal energy source heats or cools the microfluidic device by overshooting the first temperature and then reducing the overshoot until the microfluidic device reaches the first temperature.
21. The device of embodiment 20, wherein the acceleration initiates with insertion of the tray into the instrument.
22. The device of any one of embodiments 15-21 and 23-28, wherein the thermal energy source preheats or precools the tray prior to insertion into the housing.
23. The device of any one of embodiments 15-22 and 24-28, wherein the microfluidic device is placed in a thermally conductive holder, which is placed in the tray.
24. The device of any one of embodiments 15-23 and 25-28, wherein ambient temperature is between 15° C. and 30° C.
25. The device of any one of embodiments 15-24 and 26-28, wherein the first temperature is between 20° C. and 25° C.
26. The device of any one of embodiments 15-25 and 27-28, wherein the temperature of the microfluidic device reaches a temperature within 1° C. of the first temperature in less than 60 seconds.
27. The device of any one of embodiments 15-26 and 28, wherein the temperature of the microfluidic device reaches a temperature within 0.5° C. of the first temperature in less than 60 seconds.
28. The device of any one of embodiments 15-27, wherein the temperature of the microfluidic device is determined from the second temperature sensor.
29. A method for controlling temperature of a microfluidic device comprising:
   i) providing an instrument for performing an assay at a first temperature, wherein the instrument comprises a housing and a tray for inserting the microfluidic device into the housing and removing the microfluidic device from the housing, wherein the tray comprises a thermal energy source, and the instrument comprises a first temperature sensor to determine an ambient temperature and a coupling for a second temperature sensor in the microfluidic device; and
   ii) placing the microfluidic device in the tray and inserting the microfluidic device into the housing, wherein the instrument determines a difference between the ambient temperature and the first temperature and energizes the thermal energy source to heat or cool the microfluidic device by overshooting the first temperature and then reducing the overshoot until the microfluidic device reaches the first temperature or by preheating or precooling the tray relative to ambient temperature until the microfluidic device reaches the first temperature.
30. The method of any one of embodiments 29 and 31-42, wherein the thermal energy source comprises a thermoelectric cooler (TEC) comprising a heatsink.
31. The method of any one of embodiments 29-30 and 32-42, wherein the first and second temperature sensors comprise thermistors.
32. The method of any one of embodiments 29-31 and 33-42, wherein the thermal energy source heats or cools the microfluidic device by overshooting the first temperature and then reducing the overshoot until the microfluidic device reaches the first temperature.
33. The method of embodiment 32, wherein the overshoot initiates with insertion of the tray into the instrument.
34. The method of any one of embodiments 29-33 and 35-42, wherein the thermal energy source preheats or precools the tray prior to insertion into the housing.
35. The method of any one of embodiments 29-34 and 36-42, wherein the microfluidic device is placed in a thermally conductive holder, which is placed in the tray.
36. The method of any one of embodiments 29-35 and 37-42, wherein the ambient temperature is between 15° C. and 30° C.
37. The method of any one of embodiments 29-36 and 38-42, wherein the first temperature is between 20° C. and 25° C.
38. The method of any one of embodiments 29-37 and 39-42, wherein the temperature of the microfluidic device reaches a temperature within 1° C. the first temperature in less than 60 seconds.
39. The method of any one of embodiments 29-38 and 40-42, wherein the temperature of the microfluidic device reaches a temperature within 0.5° C. of the first temperature in less than 60 seconds.
40. The method of any one of embodiments 29-39 and 41-42, wherein the temperature of the microfluidic device is determined from the second temperature sensor.
41. The method of any one of embodiments 29-40, wherein the coupling is wireless.
42. The method of any one of embodiments 29-40, wherein the coupling is physically mates with the microfluidic device.
43. A device comprising:
   i) a housing and a tray for inserting a microfluidic device into the housing and removing the microfluidic device from the housing; and
   ii) a thermal energy source, a first temperature sensor to determine an ambient temperature and a coupling for a second temperature sensor in the microfluidic device;
wherein the device is programmed to determine a difference between the ambient temperature and a first temperature and energizes the thermal energy source to heat or cool the microfluidic device by overshooting the first temperature and then reducing the overshoot until the microfluidic device reaches the first temperature or by preheating or precooling the tray relative to ambient until the microfluidic device reaches the first temperature.
44. The device of any one of embodiments 43 and 45-56, wherein the thermal energy source comprises a thermoelectric cooler (TEC) comprising a heatsink.
45. The device of any one of embodiments 43-44 and 46-56, wherein the first and second temperature sensors comprise thermistors.
46. The device of any one of embodiments 43-45 and 47-56, wherein the thermal energy source heats or cools the microfluidic device by overshooting the first temperature and then reducing the overshoot until the microfluidic device reaches the first temperature.
47. The device of embodiment 46, wherein the acceleration initiates with insertion of the tray into the instrument.
48. The device of any one of embodiments 43-47 and 49-56, wherein the thermal energy source preheats or precools the tray prior to insertion into the housing.
49. The device of any one of embodiments 43-48 and 50-56, wherein the microfluidic device is placed in a thermally conductive holder, which is placed in the tray.
50. The device of any one of embodiments 43-49 and 51-56, wherein ambient temperature is between 15° C. and 30° C.
51. The device of any one of embodiments 43-50 and 52-56, wherein the first temperature is between 20° C. and 25° C.
52. The device of any one of embodiments 43-51 and 53-56, wherein the temperature of the microfluidic device reaches a temperature within 1° C. of the first temperature in less than 60 seconds.
53. The device of any one of embodiments 43-52 and 54-56, wherein the temperature of the microfluidic device reaches a temperature within 0.5° C. of the first temperature in less than 60 seconds.
54. The method of any one of embodiments 43-53 and 55-56, wherein the temperature of the microfluidic device is determined from the second temperature sensor.
55. The method of any one of embodiments 43-54, wherein the coupling is wireless.
56. The method of any one of embodiments 43-54, wherein the coupling is physically mates with the microfluidic device.

### OTHER EMBODIMENTS

While the invention has been described in connection with specific embodiments thereof, it will be understood that it is capable of further modifications and this application is intended to cover any variations, uses, or adaptations of the invention following, in general, the principles of the invention and including such departures from the invention that come within known or customary practice within the art to which the invention pertains and may be applied to the essential features hereinbefore set forth, and follows in the scope of the claims. Other embodiments are within the claims.

1. A method for controlling temperature of a microfluidic device comprising:
i) providing an instrument for performing an assay at a first temperature, wherein the instrument comprises a housing and a tray for inserting the microfluidic device into the housing and removing the microfluidic device from the housing, wherein the tray comprises a thermal energy source, and the instrument comprises a first temperature sensor to determine an ambient temperature and a second temperature sensor to determine the temperature of the tray and/or microfluidic device; and
ii) placing the microfluidic device in the tray and inserting the microfluidic device into the housing, wherein the instrument determines a difference between the ambient temperature and the first temperature and energizes the thermal energy source to heat or cool the microfluidic device by overshooting the first temperature and then reducing the overshoot until the microfluidic device reaches the first temperature or by preheating or precooling the tray relative to ambient temperature until the microfluidic device reaches the first temperature.

2. The method of claim 1, wherein the thermal energy source comprises a thermoelectric cooler (TEC) comprising a heatsink.

3. The method of claim 1, wherein the first and second temperature sensors comprise thermistors.

4.-5. (canceled)

6. The method of claim 1, wherein the thermal energy source heats or cools the microfluidic device by overshooting the first temperature and then reducing the overshoot until the microfluidic device reaches the first temperature.

7. The method of claim 6, wherein the overshoot initiates with insertion of the tray into the instrument.

8. The method of claim 1, wherein the thermal energy source preheats or precools the tray prior to insertion into the housing.

9. The method of claim 1, wherein the microfluidic device is placed in a thermally conductive holder, which is placed in the tray.

10. The method of claim 1, wherein the ambient temperature is between 15° C. and 30° C.

11. The method of claim 1, wherein the first temperature is between 20° C. and 25° C.

12. The method of claim 1, wherein the temperature of the microfluidic device reaches a temperature within 1° C. the first temperature in less than 60 seconds.

13. The method of claim 1, wherein the temperature of the microfluidic device reaches a temperature within 0.5° C. of the first temperature in less than 60 seconds.

14. A device comprising:
i) a housing and a tray for inserting a microfluidic device into the housing and removing the microfluidic device from the housing; and
ii) a thermal energy source, a first temperature sensor to determine an ambient temperature and a second temperature sensor to determine temperature of the tray and/or microfluidic device;
wherein the device is programmed to determine a difference between the ambient temperature and a first temperature and energizes the thermal energy source to heat or cool the microfluidic device by overshooting the first temperature and then reducing the overshoot until the microfluidic device reaches the first temperature or by preheating or precooling the tray relative to ambient until the microfluidic device reaches the first temperature.

15. The device of claim 14, wherein the thermal energy source comprises a thermoelectric cooler (TEC) comprising a heatsink.

16. The device of claim 14, wherein the first and second temperature sensors comprise thermistors.

17. The device of claim 14, further comprising a third temperature sensor for the microfluidic device.

18. The device of claim 17, wherein the third temperature sensor is an infrared sensor.

19. The device of claim 14, wherein the thermal energy source heats or cools the microfluidic device by overshooting the first temperature and then reducing the overshoot until the microfluidic device reaches the first temperature.

20. The device of claim 19, wherein the acceleration initiates with insertion of the tray into the instrument.

21. The device of claim 14, wherein the thermal energy source preheats or precools the tray prior to insertion into the housing.

22. The device of claim 14, wherein the microfluidic device is placed in a thermally conductive holder, which is placed in the tray.

23.-26. (canceled)
